(19) United States
(12) Patent Application Publication
(10) Pub. No.: US 2010/0281876 A1
(43) Pub. Date: Nov. 11, 2010

(54) FUEL BLANKETING BY INERT GAS OR LESS REACTIVE FUEL LAYER TO PREVENT FLAME HOLDING IN PREMIXERS

(76) Inventors: Abdul Rafey Khan, Greenville, SC (US); Balachandar Varatharajan, Loveland, OH (US); Gilbert Otto Kraemer, Greer, SC (US); Ertan Yilmaz, Glenville, NY (US); Benjamin Lacy, Greer, SC (US); William David York, Greer, SC (US)

Correspondence Address: NIXON & VANDERHYE P.C., 901 NORTH GLEBE ROAD, 11TH FLOOR, ARLINGTON, VA, 22203, US

(21) Appl. No.: 12/435,651

(22) Filed: May 5, 2009

(51) Int. Cl. F02C 7/22; F02C 3/20

(52) U.S. Cl. 60/772; 60/737; 60/39.463

(57) ABSTRACT

A premixer for a gas turbine combustor includes a first passage configured to inject a highly reactive fuel; and a second passage configured to inject an inert gas or a less reactive fuel or a mixture of both. The second passage is configured to form a layer of the inert gas or less reactive fuel or the mixture of both that blankets a layer of the highly reactive fuel. Another premixer includes a plurality of nozzles, each nozzle including a pair of concentric tubes, the pair of concentric tubes including a first tube configured to inject a highly reactive fuel and a second tube surrounding the first tube and configured to dispense an inert gas or a less reactive fuel or a mixture of both that blankets the highly reactive fuel.

### STATEMENT REGARDING FEDERALLY SPONSORED RESEARCH OR DEVELOPMENT

This invention was made with Government support under Contract No. DE-FC26-05NT42643 awarded by the Department of Energy. The Government has certain rights in this invention.

### FIELD OF THE INVENTION

The present invention relates to an air fuel mixer for the combustor of a gas turbine engine, and to a method for mixing air and fuel.

### BACKGROUND OF THE INVENTION

Gas turbine manufacturers are regularly involved in research and engineering programs to produce new gas turbines that will operate at high efficiency without producing undesirable air polluting emissions. The primary air polluting emissions usually produced by gas turbines burning conventional hydrocarbon fuels are oxides of nitrogen, carbon monoxide, and unburned hydrocarbons. The oxidation of molecular nitrogen in air breathing engines is highly dependent upon the maximum hot gas temperature in the combustion system reaction zone. The rate of chemical reactions forming oxides of nitrogen (NOx) is an exponential function of temperature, therefore the NOx generated by these reactions is also called thermal NOx. If the temperature of the combustion chamber hot gas is controlled to a sufficiently low level, thermal NOx will not be produced.

One method of controlling the temperature of the reaction zone of a combustor below the level at which thermal NOx is formed is to premix fuel and air to a lean mixture prior to combustion. The thermal mass of the excess air present in the reaction zone of a lean premixed combustor absorbs heat and reduces the temperature rise of the products of combustion to a level where thermal NOx is not formed.

There are several potential problems associated with dry low emissions combustors operating with lean premixing of fuel and air in which flammable mixtures of fuel and air exist within the premixing section of the combustor, which is external to the reaction zone of the combustor. There may be a tendency for combustion to occur within the premixing section due to flashback, which occurs when flame propagates from the combustor reaction zone into the premixing section and causes the flame to hold inside the wake flows behind the fuel injection columns (jet cross flow) or vane trailing edges, or autoignition, which occurs when the dwell time and temperature for the fuel/air mixture in the premixing section are sufficient for combustion to be initiated without an igniter. The consequences of combustion in the premixing section are degradation of emissions performance and/or overheating and damage to the premixing section, which is typically not designed to withstand the heat of combustion. Therefore, a problem to be solved is to prevent flashback or autoignition resulting in combustion within the premixer.

In addition, the mixture of fuel and air exiting the premixer and entering the reaction zone of the combustor should be very uniform to achieve the desired emissions performance. If regions in the flow field exist where fuel/air mixture strength is significantly richer than average, the products of combustion in these regions will reach a higher temperature than average, and thermal NOx may be formed. This can result in failure to meet NOx emissions objectives depending upon the combination of temperature and residence time. If regions in the flow field exist where the fuel/air mixture strength is significantly leaner than average, then flame quenching may occur with failure to oxidize hydrocarbons and/or carbon monoxide to equilibrium levels. This can result in failure to meet carbon monoxide (CO) and/or unburned hydrocarbon (UHC) emissions objectives. Thus, another problem to be solved is to produce a fuel/air mixture strength distribution, exiting the premixer, which is sufficiently uniform to meet emissions performance objectives.

Still further, in order to meet the emissions performance objectives imposed upon the gas turbine in many applications, it is necessary to reduce the fuel/air mixture strength to a level that is close to the lean flammability limit for most hydrocarbon fuels. This may result in a reduction in flame propagation speed as well as emissions. As a consequence, lean premixing combustors may tend to be less stable than more conventional diffusion flame combustors, and high levels of combustion driven dynamic pressure fluctuation (also called combustion dynamics) often results. Combustion dynamics can have adverse consequences such as combustor and turbine hardware damage due to wear or fatigue, flashback or blow out. Accordingly, another problem to be solved is to control the combustion dynamics to an acceptably low level.

Lean, premixing fuel injectors for emissions abatement are in use throughout the industry, having been reduced to practice in heavy duty industrial gas turbines for more than two decades. A representative example of such a device is described in U.S. Pat. No. 5,259,184. Such devices have achieved progress in the area of gas turbine exhaust emissions abatement. Reduction of oxides of nitrogen, NOx, emissions by an order of magnitude or more relative to the diffusion flame burners of the prior art have been achieved without the use of diluent injection such as steam or water.

As noted above, however, these gains in emissions performance may have been made at the risk of incurring several problems. In particular, flashback and flame holding within the premixing section of the device result in degradation of emissions performance and/or hardware damage due to overheating. In addition, increased levels of combustion driven dynamic pressure activity results in a reduction in the useful life of combustion system parts and/or other parts of the gas turbine due to wear or high cycle fatigue failures. Still further, gas turbine operational complexity is increased and/or operating restrictions on the gas turbine are necessary in order to avoid conditions leading to high-level dynamic pressure activity, flashback, or blow out.

In addition to these problems, conventional lean premixed combustors may have not achieved maximum emission reductions possible with perfectly uniform premixing of fuel and air exiting the premixer and entering the reaction zone.

### BRIEF DESCRIPTION OF THE INVENTION

According to an embodiment, a premixer for a gas turbine combustor comprises a first passage configured to inject a highly reactive fuel; and a second passage configured to inject an inert gas or a less chemically reactive fuel or a mixture of both, wherein the second passage is configured to form a layer of the inert gas or the less reactive fuel or the mixture of both that blankets a layer of the highly reactive fuel.

According to another embodiment, a premixer for a gas turbine combustor comprises a plurality of nozzles, each nozzle comprising a pair of concentric tubes, the pair of concentric tubes comprising a first tube configured to inject a highly reactive fuel and a second tube surrounding the first tube and configured to inject an inert gas or a less reactive fuel or a mixture of both that blankets the highly reactive fuel.

According to still another embodiment, a method of forming a combustible mixture for a gas turbine combustor comprises injecting a highly reactive fuel; and injecting an inert gas or a less reactive fuel or a mixture of both, wherein the inert gas or the less reactive fuel or the mixture of both blankets the highly reactive fuel.

### BRIEF DESCRIPTION OF THE DRAWINGS

FIG. 1 schematically depicts a premixer comprising a diffused horizontal fuel passage and an inert and/or less reactive fuel passage;

FIG. 2 schematically depicts fuel blanketing by inert and/or less reactive fuel according to the premixer of FIG. 1;

FIG. 3 schematically depicts a premixer comprising a plurality of burner tubes within a tube according to another embodiment;

FIGS. 4-11 schematically depict first and second passages according to other embodiments.

### DETAILED DESCRIPTION OF THE INVENTION

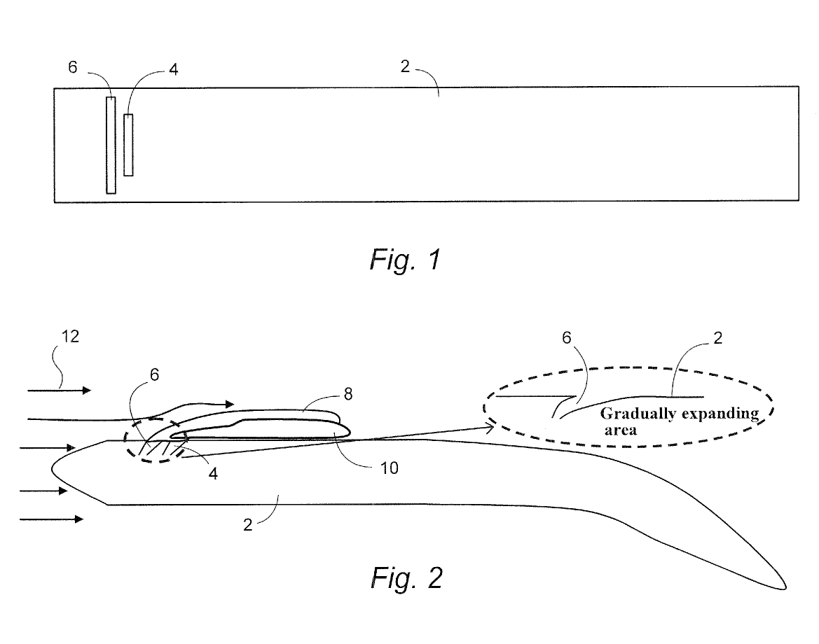

Referring to FIGS. 1 and 2, a hub and shroud section 2 of a premixer of a combustor includes a first passage 4 and a second passage 6. Fuel 10 is provided from the first passage 4. The fuel 10 may be highly reactive fuel, for example hydrogen (H₂) or fuels having high hydrogen levels. The fuel 10 may also be, for example, natural gas, liquid fuel, gas from coal gasification, synthetic fuels, and hydrocarbon fuels or fuels having high hydrocarbon levels. The fuel 10 is mixed with a flow of air 12 to form a fuel-air mixture for combustion. It should be appreciated that the inert gas and/or less reactive fuel may also be injected just after the highly reactive fuel. This may potentially decrease the reactivity of the recirculation zone induced by fuel injection and, therefore, the propensity for flame holding.

An inert gas or a less reactive fuel or a mixture of both 8 is provided from the second passage 6. The inert gas may be, for example, nitrogen (N₂), or steam (H₂O), or carbon dioxide (CO₂) or a combination thereof. The first, or fuel, passage 4 is configured to keep the fuel 10 away from the hub and shroud section 2 where the fuel 10 could be trapped and cause flame holding. As shown in detail in FIG. 2, the second passage 6 has a gradually expanding area. The second passage 6 is wider than the fuel passage 4 as shown in FIG. 1 and extends to the hub and shroud section 2 to completely cover the fuel layer 10.

The flame holding margin may be increased by blanketing the highly reactive fuel 10 by the layer of inert gas or less reactive fuel or mixture of both 8 as shown in FIG. 2 to control early onset of combustion due to flow related issues. For highly reactive fuels, like hydrogen, flow disturbances can trap fuel and start a flame holding problem.

The passages 4, 6 are used to slowly diffuse and form the layer of highly reactive fuel 10 covered by the inert gas or less reactive fuel 8 and retard the reaction between the fuel air interface. As shown in detail in FIG. 2, the second passage 6 has a gradually expanding area, although it should be appreciated that both the first and second passages 4, 6 may include gradually expanding areas to slowly diffuse the streams of inert gas or less reactive fuel and the highly reactive fuel via the gradual expanding areas. The passages 4, 6 are configured to provide generally uniform distribution and form the layer of inert gas or less reactive fuel 8 over the highly reactive fuel 10. Flow introduction via gradual expansion also reduces jet induced separation seen at the vane surfaces.

Flame holding may also be prevented for the highly reactive fuel 10 by controlling the air fuel interaction near the fuel introduction space. The passages 4, 6 are also configured to control the air/fuel mixing interface to control ignition.

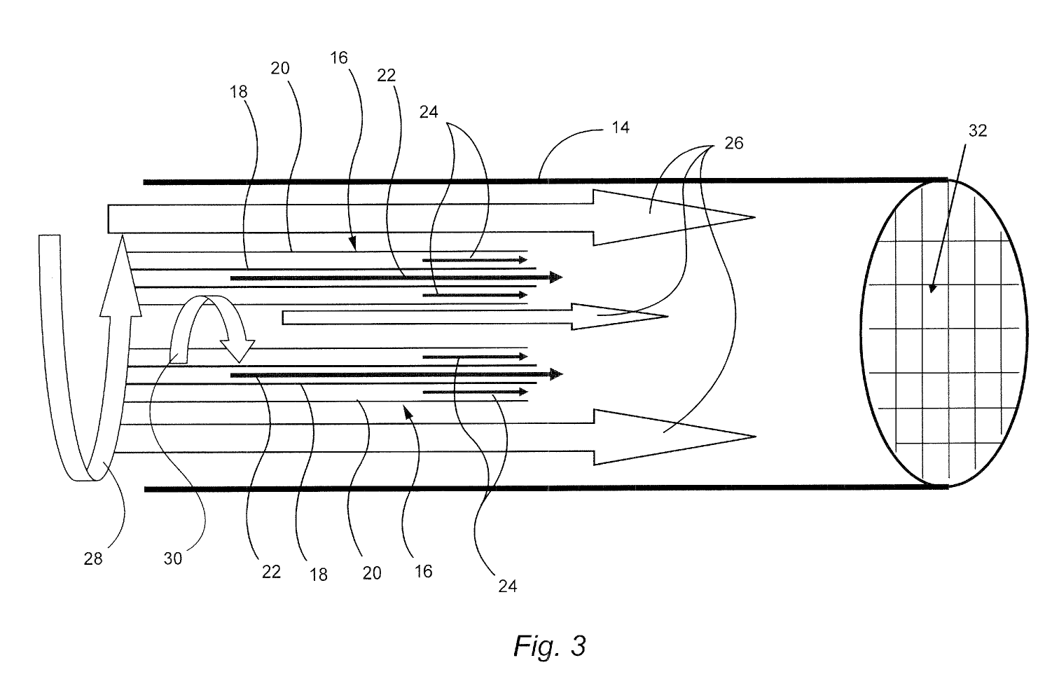

The blanketing of a highly reactive fuel by an inert gas or a less reactive fuel can also be used in a concentric tubes arrangement as shown in FIG. 3.

A combustor 14 includes a premixer comprising nozzles 16. Each nozzle 16 includes concentric tubes, including an inner tube 18 and an outer tube 20. The inner tube 18 provides fuel 22, for example highly reactive fuel, and the outer tube 20 provides an inert gas or less reactive fuel 24 that blankets the fuel 22. A flow of air 26 is provided to the combustor 14 to form a combustible mixture with the fuel 22. The air flow 26 may include a swirl 28 and a counter-swirl 28. A flashback arrestor 30 may also be provided.

The premixer can be used for machines that require high hydrogen fuels or high hydrogen syngas fuels.

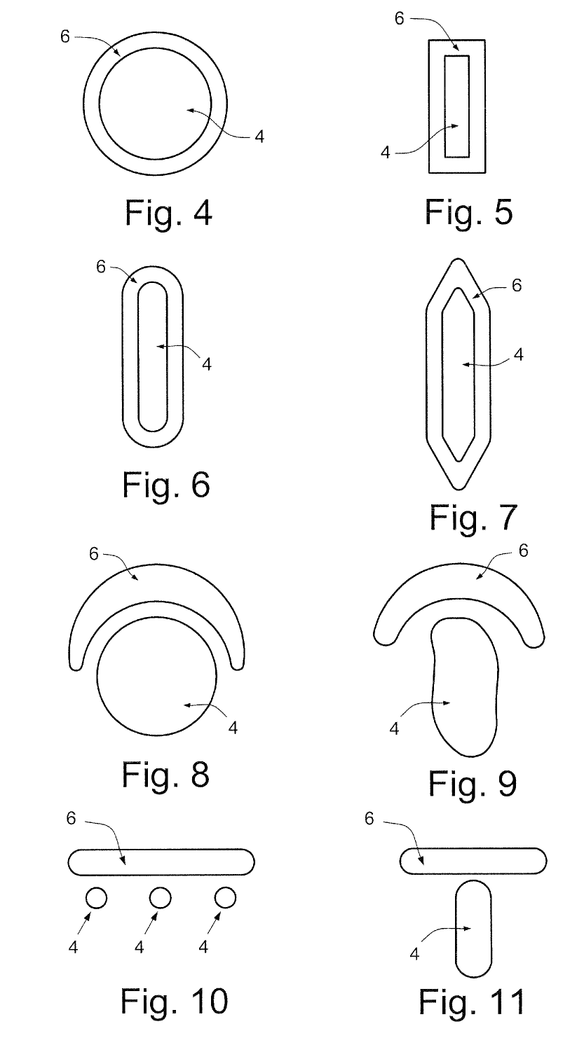

Referring to FIGS. 4-11, the passages 4, 6 may have various configurations. For example, the passages 4, 6, may be circular, as shown in FIG. 4, or rectangular as shown in FIG. 5. The passages 4, 6 may also be a combination of shapes, as shown in FIGS. 6-8. As shown in FIG. 10, one of the passages 4 may be formed as a plurality of passages. It should also be appreciated that both passages may be formed as a plurality of passages. Referring to FIG. 11, the passages may be provided perpendicularly to one another.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A premixer for a gas turbine combustor, comprising:
a first passage configured to inject a highly reactive fuel; and
a second passage configured to inject an inert gas or a less reactive fuel or a mixture of both, wherein the second passage is configured to form a layer of the inert gas or less reactive fuel or the mixture of both that blankets a layer of the highly reactive fuel.

2. A premixer according to claim 1, wherein the second passage is wider than the first passage.

3. A premixer according to claim 1, wherein the second passage comprises an expanding area.

4. A premixer according to claim 1, wherein the first passage is configured to diffuse the highly reactive fuel away from a hub and shroud section.

5. A premixer according to claim 4, wherein the second passage extends to the hub and shroud section to diffuse the inert gas or less reactive fuel or the mixture of both to completely cover the first passage.

6. A premixer for a gas turbine combustor, comprising:
a plurality of nozzles, each nozzle comprising a pair of concentric tubes, the pair of concentric tubes comprising a first tube configured to inject a highly reactive fuel and a second tube surrounding the first tube and configured to inject an inert gas or a less reactive fuel or a mixture of both that blankets the highly reactive fuel.

7. A premixer according to claim 6, further comprising a flashback arrestor.

8. A method of forming a combustible mixture for a gas turbine combustor, the method comprising:
injecting a highly reactive fuel; and
injecting an inert gas or a less reactive fuel or a mixture of both, wherein the inert gas or the less reactive fuel or the mixture of both blankets the highly reactive fuel.

9. A method according to claim 8, wherein injecting the highly reactive fuel comprises injecting the highly reactive fuel from a first passage and injecting the inert gas or the less reactive fuel or the mixture of both comprises injecting the inert gas or the less reactive fuel or the mixture of both from a second passage.

10. A method according to claim 9, wherein the second passage is wider than the first passage.

11. A method according to claim 9, wherein the second passage has a gradually expanding area.

12. A method according to claim 9, wherein the second passage extends to a hub and shroud of a premixer to inject the inert gas or less reactive fuel or the mixture of both to completely cover the highly reactive fuel.

13. A method according to claim 12, wherein the first passage is configured to inject the highly reactive fuel away from the hub and shroud.

14. A method according to claim 8, wherein injecting the highly reactive fuel comprises injecting the highly reactive fuel from a first tube and injecting the inert gas or less reactive fuel or the mixture of both from a second tube that is concentric with the first tube.

15. A method according to claim 8, further comprising:
providing an air flow to mix with the inert gas or the less reactive fuel or the mixture of both and the highly reactive fuel.

16. A method according to claim 15, further comprising:
providing a swirl to the air flow.

17. A method according to claim 16, further comprising:
providing a counter-swirl to the air flow.

18. A method according to claim 8, wherein the inert gas comprises CO₂ or N₂ or steam H₂O.

19. A method according to claim 8, wherein the highly reactive fuel comprises high hydrogen fuels or high hydrogen syngas fuels.
